(19) United States
(12) Patent Application Publication
(10) Pub. No.: US 2026/0035603 A1
(43) Pub. Date: Feb. 5, 2026

(54) A FOAMY COMPOSITION TO PREVENT PLANTS FROST

(71) Applicant: Yahya DASHTI RAHMATABADI, Tehran (IR)

(72) Inventors: Yahya DASHTI RAHMATABADI, Tehran (IR); Javad MOKHTARI ALIABAD, Tehran (IR)

(21) Appl. No.: 18/995,205

(22) PCT Filed: Oct. 28, 2022
(86) PCT No.: PCT/IB2022/060410

§ 371 Date: Jan. 16, 2025

(30) Foreign Application Priority Data
Jul. 16, 2022 (IR) 14015014000300301

(51) Int. Cl. C09K 3/18

(52) U.S. Cl. CPC C09K 3/18

(57) ABSTRACT

A foamy composition for preventing frost in plants comprise a hydrolyzed protein compound, a bubble stabilizer, a bubble stability enhancer, and a wetting agent. The hydrolyzed protein compound contain a plurality of amino acids that at least one of the amino acids have a foaming capability. The source of the amino acids can be a plant or an animal source, so that the foamy composition also performs as a growth stimulant and plant strengthening. It leads to the improvement of the plant growth and reproduction.

The present disclosure application claims priority from pending IRAN Patent Application Serial No. 140150140003003016, filed on Jul. 16, 2022, entitled “A FOAM COMPOUND FOR PROTECTION PLANTS FROM FROST”, which is incorporated by reference herein in its entirety

### TECHNICAL FIELD

The present disclosure is related to a production of a biocompatible foamy composition of amino acids extracted from a plant or animal protein source, particularly extracted from a mammal's wool, to prevent plants and/or agricultural products from frost.

### BACKGROUND ART

One of the biggest damages in the agricultural industry is the sudden drop in the air temperature and as a result, the freezing of plants at the end of winter and early spring, which in many cases may cause the complete destruction of agricultural products and damage to farmers.

Several methods have been used to prevent plants and agricultural products from freezing and frost. In many of these methods, chemical compounds and products have been used to prevent plants and agriculture products from frost. The use of these chemical compounds and products on the one hand leads to environmental pollution, and on the other hand, they may have a negative effect on the growth and final yield of the agricultural products. Therefore, there is a need to develop a biocompatible as well as easy-made product that the product has a positive effect on the growth and cultivation of the agricultural products in addition to creating an anti-freeze properties.

Among the various effective composition in the growth and breeding of the agricultural products, the amino acids are among the composition that are used as the anti-stress composition, the chelating composition, and also transport micronutrients in plants. On the other hand, some amino acids extracted from the various protein sources have foaming properties, which makes them suitable candidates for the production of the anti-freeze and anti-frost products.

So, herein a biocompatible and long-lasting anti-frost composition is developed based on at least one amino acid that has foaming properties and prevents plants and agricultural products from frost.

### SUMMARY OF INVENTION

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In a general aspect, the present disclosure is directed to an exemplary foamy composition to prevent plants from frost. The exemplary foamy composition may comprise a hydrolyzed protein compound, a bubble stabilizer, and a bubble stability enhancer.

The above general aspect may have one or more of the following features. In an exemplary implementation, the exemplary foamy composition may further comprise a wetting agent. In an exemplary implementation, the hydrolyzed protein compound may comprise at least one amino acid or a plurality of amino acids with a foaming capability. In an exemplary implementation, the hydrolyzed protein compound may be based on a vegetable protein, an animal protein, or a combination thereof. In some exemplary implementation, the vegetable protein may comprise a protein extracted from soybeans, wheat, peas, or a combination thereof. In some exemplary implementation, the animal protein may comprise a protein extracted from a horn of an animal, a venom of an animal, a blood of an animal, a wool of an animal, or a combination thereof. In an exemplary implementation, the hydrolyzed protein may comprise a sheep wool extracted hydrolyzed protein. In an exemplary implementation, the bubble stabilizer may comprise a divalent metal sulfate, a trivalent metal sulfate, or a combination thereof. In an exemplary implementation, the bubble stability enhancer may comprise a polysaccharide, a non-saccharide polymer, or a combination thereof. In some exemplary implementation, the polysaccharide may include Guara, Scleroglucan, a hydrolyzed starch, xanthan gum, gum arabic, or a combination thereof. In some exemplar implementation, the non-saccharide includes an acrylic acid polymer, a polyethylene oxide, a polyacrylamide, or a combination thereof. In an exemplary implementation, a plurality of glucitols, a plurality of glycerol compounds, a plurality of glycols, or a combination thereof may be used as the wetting agent. In an exemplary implementation, a foamy composition stability on a plant may be in a range of 8 hours to 24 hours. In a particular exemplary implementation, when the weather is very cold, a foamy composition stability on a plant may be more than 24 hours.

### Advantageous Effects of Invention

The applying foamy composition based on the amino acids extracted from a plant source or an animal source, consistent with one or more exemplary has the following advantages:
a simple, cheap, and applicable composition to prevent frost in the plants and agricultural products;
having an ability to be industrialized on a large scale;
using the natural resources to extract amino acids with suitable foaming ability;
the organic nature of the produced composition environmentally friendly; and
acting as a growth factor and strengthening the plants and agricultural products.

### DESCRIPTION OF EMBODIMENTS

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings. The following detailed description is, therefore, not to be taken in a limiting sense, and the scope of the present disclosure is defined only by the appended claims.

The following detailed description is presented to enable a person skilled in the art to make and use the methods and apparatuses disclosed in exemplary embodiments of the present disclosure. For purposes of explanation, specific nomenclature is set forth provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

In an exemplary embodiment, an exemplary foamy composition may be applied to prevent plants from the frost or freezing. In an exemplary embodiment, an exemplary foamy composition may be made based on a hydrolyzed protein compound.

As used herein, the term “a plant”, “a target plant”, “plants” may refer to a crop, a tree, a cacti, and a succulent.

In an exemplary embodiment, a foamy composition for preventing plants from the freezing or frost may comprise at least three main components. In an exemplary embodiment, a first component may comprise at least one hydrolyzed protein compound, and a second and third components may comprise a bubble stabilizer and a bubble stability enhancer, respectively. The exemplary foamy composition may have some advantages such as preventing freezing and frost of plants, growth stimulant and plant enhancer, as well as increasing the yield of agricultural products.

In another exemplary embodiment, an exemplary foamy composition may further comprise a wetting agent.

In an exemplary embodiment, the hydrolyzed protein compound may comprise at least one amino acid capable of foaming. In another exemplary embodiment, the hydrolyzed protein compound may comprise a plurality of amino acids. In this exemplary embodiment, each or some of the plurality of amino acids have a foaming ability. In an exemplary embodiment, the hydrolyzed protein compound may comprise a plant protein compound, an animal protein compound, or a combination thereof. In an exemplary embodiment, the plant protein compound may be extracted from, for example, but not limited to, soybeans, wheat seeds, pea seeds, or a combination thereof. In an exemplary embodiment, the animal protein compound may be derived from, for example, but not limited, the horn of an animal, the hoof of an animal, the wool of an animal, the blood of an animal, the feathers of a bird, or a combination thereof.

In an exemplary embodiment, the animal protein compound may be derived from a mammal. In a particular embodiment, the mammal may comprise a ruminant mammal.

In an exemplary embodiment, the animal protein compound may be derived from a mammal's wool. In this exemplary embodiment, the mammal may comprises a sheep, rabbits, goats, alpacas, and the like.

In a particular embodiment, the hydrolyzed protein compound may be extracted from a sheep product. In a more particular embodiment, the hydrolyzed protein compound may be derived from a sheep wool. In an exemplary embodiment, the hydrolyzed protein compound derived from the sheep wool may comprise at least sixteen different types of amino acids. In an exemplary embodiment, the derived sixteen different types of amino acids may include aspartic acid, glutamic acid, serine, histidine, arginine, threonine, alanine, proline, tyrosine, valine, methionine, cysteine, isoleucine, leucine, phenylalanine, and/or lysine.

As used herein, the term “sheep” may refer to a ewe, a ram, a lamb, a goat, a wether, and a geep.

In an exemplary embodiment, the bubble stabilizer may comprise a divalent metal sulfate, a trivalent metal sulfate, or a combination thereof. In an exemplary embodiment, the divalent metal sulfate may comprise, for example, but not limited to, iron sulfate, copper sulfate, magnesium sulfate, zinc sulfate, calcium sulfate, and the like. In another exemplary embodiment, the trivalent metal sulfate may comprise, for example, but not limited to, trivalent iron sulfate, aluminum sulfate, and the like. In an embodiment, the bubble stabilizer may be added to the hydrolyzed protein compound. at a percentage in a range of 1 to 7% (by weight).

In an exemplary embodiment, the bubble stability enhancer may be used in order to increase the bubble stability time. In an exemplary embodiment the bubbler stability enhancer may be used in the presence of the bubble stabilizer. In an embodiment, the bubble stability enhancer may comprise, for example, but not limited to, a polysaccharide, a non-saccharide polymer, or a combination thereof. In an exemplary embodiment, an additive amount of the bubble stability enhancer to the hydrolyzed protein compound may be in a range of 0.1 to 2% (by weight). In an exemplary embodiment, the polysaccharide may include, for example, but not limited to, Guara, Scleroglucan, a hydrolyzed starch, xanthan gum, gum arabic, or a combination thereof. In an exemplary embodiment, the non-saccharide polymer may include, for example, but not limited to, an acrylic acid polymer, a polyethylene oxide, a polyacrylamide polymer, or a combination thereof. In these exemplary embodiment, the polysaccharide and non-saccharide polymer may be used in the different molecular weights.

In an exemplary embodiment, the wetting agent may comprise a variety of sorbitols, a variety of glycerol compounds, a variety of glycols, or a combination thereof. In an exemplary embodiment, the wetting agent may be added to the foamy composition at a concentration of 1% to 3% w/w.

In an exemplary embodiment, the foamy composition in a range of 2% to 5% (by weight) may be mixed with 98 to 95% volume of water and a prepared mixture may be sprayed in a form of a plurality of foam bubbles on a target plant utilizing a foaming device. The foam bubbles can be covered all parts of the target plant, for example, but not limited to, the leaves, stem, and branch, so on can prevent the plant from frost as well as freezing. The foam bubbles can be dry, spongy, and have a suitable resistance to maintain the foam form of themselves. The stability of the foam bubbles on the target plant depends on the environmental conditions including environmental humidity, environmental temperature, wind speed, intense of sunlight, etc. In an exemplary embodiment, the stability of the foamy composition on the target plant may be in a range of 8 hours and 24 hours depending on the environmental conditions.

In an exemplary embodiment, in a case that a temperature of the environment drops below zero, an outer surface of the foam bubbles of the foamy composition can freeze. In this case, the stability of the foam bubbles on the target plant may be more than 24 hours. The increase in the stability of the foam bubbles may occur because the frozen foam bubbles remain stable until the environmental temperature rises again and after raising the temperature the frozen foam bubbles melt on the target plant. In an exemplary embodiment, when the temperature rises above zero degrees and there is a possibility that the temperature will drop again, a new plurality of foam bubbles may be sprayed on the target plant every 12 hours and/or every 24 hours in accordance with the weather warnings in order to prevent the plant from frost and freezing.

In an exemplary embodiment, the foamy composition may prevent a transfer of the cold to the target plant up to 80%. In this case, due to the prevention of cold penetration to the surface of the target plant, a creation of a suitable cover, as well as a transfer of heat from the soil surface to the target plant cause a creation of a suitable environment to protect the target plant from the cold weather and frost.

The foamy composition can be used in different fields such as agricultural industry, flower and ornamental plants, green spaces architecture, forestry, and the like.

The following example is put forth so as to provide those of ordinary skill in the art with a complete disclosure and description of how to make and use the present invention, and are not intended to limit the scope of what the inventors regard as their invention nor are they intended to represent that the experiments below are all or the only experiments performed.

### EXAMPLE

### Example 1: Producing a Foamy Composition Based on a Sheep Wool Hydrolyzed Protein Compound

In Example 1, an exemplary foamy composition was produced based on the sheep wool to protect a plant from frost and freezing, consistent with the teachings of the exemplary embodiments of the present disclosure. For producing the exemplary foamy composition, a certain amount of the sheep wool is poured into a reactor and an extracting process for obtaining an exemplary hydrolyzed protein compound in presence of a sodium hydroxide (NaOH) solution at a concentration of 1 M was carried out for about 24 hours. The obtained hydrolyzed protein compound has a viscous liquid form and a brown color that has a significant and suitable foaming ability. The obtained hydrolyzed protein compound was analyzed to determine the types of its amino acids as well as an amount of the free amino acids. The results was illustrated below in Table.1.

TABLE 1
Different types of extracted amino acids from the hydrolysis
of sheep wool to produce foamy composition

| | Total Amino Acid | Free Amino Acid |
|---|---|---|
| Amino Acid Type | (mg AA/g sheep wool) | (mg AA/g sheep wool) |
| Aspartic Acid | 21.7 | 1.57 |
| Glutamic Acid | 67.72 | 3.35 |
| Serin | 1.14 | 0.57 |
| Glycine | 24.12 | 11.92 |
| Histidine | 2.43 | 0.90 |
| Arginine | 26.61 | 0.53 |
| Threonine | 12.13 | 0.12 |
| Alanine | 12.98 | 13.68 |
| Proline | 8.35 | 7.33 |
| Tyrosine | 11.88 | 1.69 |
| Valine | 20.52 | 14/2 |
| Methionine | 1.97 | 0.34 |
| Cysteine | 0/27 | 0.36 |
| Isoleucine | 8.52 | 0.83 |
| Lucien | 29.24 | 2.54 |
| Phenylalanine | 6.25 | 1.71 |
| Lysine | 7.86 | 0.44 |
| | 26.36 | 5.00 |

Following that, 1% (w/w) copper sulfate and 0.5% to 2% (w/w) of a polysaccharide were added to the obtained hydrolyzed protein compound and mixed well to obtain the sheep wool foamy composition. For applying the obtained foamy composition, a mixture was prepared by adding the obtained sheep wool foaming compound to the water in a foaming device that a volume ratio of the sheep wool to the water is 3:97 by volume. At a required time, utilizing a nozzle of the foaming device, a plurality of foam bubbles was sprayed on the target plant that the plurality of foam bubbles were produce under a pressure about 6 bars to 8 bars. The pressure was applied into the foaming device utilizing an air capsule.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood that the terms and expressions used herein have the ordinary meaning as is accorded to such terms and expressions with respect to their corresponding respective areas of inquiry and study except where specific meanings have otherwise been set forth herein. Relational terms such as first, second, and third and the like may be used solely to distinguish one entity or action from another without necessarily requiring or implying any actual such relationship or order between such entities or actions. The terms “comprises,” “comprising,” “include,” “including,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element. Moreover, “may,” “can,” and other permissive terms are used herein for describing optional features of various embodiments. These terms likewise describe selectable or configurable features generally, unless the context dictates otherwise.

1. A foamy composition to prevent plants from frost, the foamy composition comprising:
a hydrolyzed protein compound;
a bubble stabilizer; and
a bubble stability enhancer.

2. The foamy composition according to claim 1, further comprising a wetting agent.

3. The foamy composition according to claim 1, wherein the hydrolyzed protein compound comprise at least one amino acid or a plurality of amino acids with a foaming capability.

4. The foamy composition according to claim 1 or 3, wherein the hydrolyzed protein compound is based on a vegetable protein, an animal protein, or a combination thereof.

5. The foamy composition according to claim 4, wherein the vegetable protein comprises a protein extracted from soybeans, wheat, peas, or a combination thereof.

6. The foamy composition according to claim 4, wherein the animal protein comprises a protein extracted from a horn of an animal, a venom of an animal, a blood of an animal, or a wool of an animal.

7. The foamy composition according to claim 1, wherein the hydrolyzed protein comprises a sheep wool extracted hydrolyzed protein.

8. The foamy composition according to claim 1, wherein the bubble stabilizer comprises a divalent metal sulfate, a trivalent metal sulfate, or a combination thereof.

9. The foamy composition according to claim 1, wherein the bubble stability enhancer comprises a polysaccharide, a non-saccharide polymer, or a combination thereof.

10. The foamy composition according to claim 9, wherein the polysaccharide includes Guara, Scleroglucan, a hydrolyzed starch, xanthan gum, gum arabic, or a combination thereof.

11. The foamy composition according to claim 9, wherein the non-saccharide polymer includes an acrylic acid polymer, a polyethylene oxide, a polyacrylamide, or a combination thereof.

12. The foamy composition according to claim 2, wherein the wetting agent includes a plurality of glucitols, a plurality of glycerol compounds, a plurality of glycols, or a combination thereof.

13. The foamy composition according to claim 1, wherein a foamy composition stability on a plant is in a range of 8 hours to 24 hours.

14. The foamy composition according to claim 1, wherein a foamy composition stability on a plant in a very cold weather is more than 24 hours.

15. A foamy composition to prevent frost and stimulate growth of a plant comprising:
a hydrolyzed protein compound containing at least one type of an amino acid extracted from a mammal's wool
a bubble stabilizer;
a bubble stability enhancer; and
a wetting agent.

16. The foamy composition according to claim 15, wherein the mammal is a sheep.

17. The foamy composition according to claim 15, wherein the bubble stabilizer comprises a divalent metal sulfate, a trivalent metal sulfate, or a combination thereof.

18. The foamy composition according to claim 15, wherein the bubble stability enhancer comprises a polysaccharide, a non-saccharide polymer, or a combination thereof.

19. The foamy composition according to claim 15, wherein the wetting agent includes a plurality of glucitols, a plurality of glycerol

20. The foamy composition according to claim 15, wherein a foamy composition stability on a plant is in a range of 8 hours to 24 hours.

21. The foamy composition according to claim 15, wherein a foamy composition stability on a plant in a freezing weather is more than 24 hours.
